(19) United States
(12) Patent Application Publication
(10) Pub. No.: US 2025/0231743 A1
(43) Pub. Date: Jul. 17, 2025

(54) METHOD AND APPARATUS FOR MANAGING USER-MODE PROGRAM IN TARGET OPERATING SYSTEM

(71) Applicant: Alipay (Hangzhou) Information Technology Co., Ltd., Hangzhou (CN)

(72) Inventors: Yuke PENG, Hangzhou (CN); Hongliang TIAN, Hangzhou (CN); Shoumeng YAN, Hangzhou (CN); Yinqian ZHANG, Hangzhou (CN)

(21) Appl. No.: 19/017,158

(22) Filed: Jan. 10, 2025

(30) Foreign Application Priority Data
Jan. 16, 2024 (CN) 202410066000.5

(51) Int. Cl. G06F 8/30

(52) U.S. Cl. CPC G06F 8/30

(57) ABSTRACT

Embodiments of this specification provide a method and an apparatus for managing a user-mode program in a target operating system. The target operating system is written in a Rust language. The Rust language includes an unsafe keyword. The method includes: in response to a kernel processing program requesting, by calling an interface function, to enter a user mode to execute a target program, confirming, by the user-mode interface module, security of a register access related to the request, where the kernel processing program is located at a non-privilege level and has no permission to use the unsafe keyword, and the user-mode interface module does not include the unsafe keyword; and activating, by the basic code module, a target page table corresponding to the target program through the register access by using first code that includes the unsafe keyword, and setting a mode of the operating system to the user mode.

### TECHNICAL FIELD

One or more embodiments of this specification relate to a computer operating system, and in particular, to a method and an apparatus for managing a user-mode program in an operating system.

### BACKGROUND

A Rust language is an emerging system programming language that can eliminate much of problematic code during compilation through a security check. In addition, there is no characteristics such as runtime and a garbage collection mechanism. Therefore, the Rust code runs much faster than languages such as Java and Python, and can be qualified for high-performance scenarios. These advantages make the Rust language increasingly popular.

A Rust compiler performs a mandatory check, so that no undefined behavior such as null pointer access is caused when a program runs, thereby eliminating much of problematic code during compilation. However, in Rust, there is a special keyword named unsafe, and the keyword can mark a code block to bypass some mandatory security checks on the code block by the compiler, but a programmer needs to be responsible for security of the code block. The keyword appears because there is no flexibility in some scenarios when code checked only by the compiler is used and consequently the program cannot perform special operations. To enable the program to have higher performance or implement special functions, the Rust compiler provides the unsafe keyword to grant higher permission to the program.

The unsafe keyword is mainly used in two scenarios: In a first scenario, the unsafe keyword marks a function, indicating that when using the function, the programmer needs to meet some conditions defined by the function, to ensure that the program does not generate undefined behavior. This is referred to as unsafe-marked code. In a second scenario, the unsafe keyword marks a process, including using a function or performing an unsafe operation defined by the compiler, for example, modifying a mutable static variable and dereferencing a raw pointer. This is referred to as unsafe-used code. In a scenario of the unsafe-used code, the programmer needs to ensure use security based on a condition that the function or the unsafe operation needs to meet.

The Rust language gradually demonstrates its advantages in the operating system field during development, attracting more people to use Rust to write operating systems. However, in an operating system written in Rust, use of the unsafe keyword is always a relatively significant problem. Incorrect use of the unsafe keyword is very prone to cause system instability or even crashes. Excessive use of the unsafe keyword causes a great trust burden and risk.

It is hoped that there can be an improved solution to alleviate the security and trust problems related to the unsafe keyword in the operating system written in Rust.

### SUMMARY

One or more embodiments of this specification describe a method and an apparatus for managing a user-mode program in an operating system written in Rust, to reduce a trusted base of the operating system in terms of user-mode program management, so as to improve system stability and security.

According to a first aspect, a method for managing a user-mode program in a target operating system is provided. The target operating system is written in a Rust language. The Rust language includes an unsafe keyword. The method is performed by a management module at a privilege level, and the privilege level has permission to use the unsafe keyword. The management module includes at least a user-mode interface module and a basic code module. The method includes:
in response to a kernel processing program requesting, by calling a preset interface function, to enter a user mode to execute a target program, determining, by the user-mode interface module, a to-be-executed register access based on the request, and confirming security of the register access, where the kernel processing program is located at a non-privilege level and has no permission to use the unsafe keyword, and the user-mode interface module does not include the unsafe keyword; and
activating, by the basic code module, a target page table corresponding to the target program through the register access by using first code that includes the unsafe keyword, and setting a mode of the operating system to the user mode.

According to an implementation, the confirming, by the user-mode interface module, security of the register access specifically includes:
confirming, by the user-mode interface module, that the target page table is valid; and
confirming, by the user-mode interface module, that the register access includes only one register write operation of performing writing into a base address register based on the target page table, and all other accesses are register read operations performed to implement data extraction.

Further, a memory management module is further disposed at the privilege level, and the confirming, by the user-mode interface module, that the target page table is valid includes: calling the memory management module to confirm that a base address of the target page table is not modified.

In an embodiment, the activating a target page table corresponding to the target program through the register access includes: writing a base address of the target page table into the base address register; and restoring values of several general-purpose registers, where the several general-purpose registers are configured to store a program counter, an instruction pointer, and a stack pointer.

According to an implementation, the management module further includes an intermediate module, the intermediate module does not include the unsafe keyword, and the method further includes: in response to a target trigger event that enables the operating system to enter a kernel mode, performing, by the intermediate module, target processing corresponding to the target trigger event, where the target trigger event is one of a system call, an external interrupt, or a CPU exception.

Further, in an embodiment, the performing, by the intermediate module, target processing corresponding to the target trigger event includes: when the target trigger event is a system call, returning, by the intermediate module, the kernel processing program based on running data of the target program.

According to an implementation, the management module further includes a thread management module, the thread management module does not include the unsafe keyword, and the method further includes: in response to a request for switching from a currently executed first thread in the target program to a second thread, confirming, by the thread management module, that a thread switching context is valid; and switching, by the basic code module, an execution thread to the second thread by using second code that includes the unsafe keyword.

In different examples, the second thread can be one of the following: another thread in the target program, a user-mode thread in another user-mode program, and a kernel thread.

In an embodiment, the thread management module has a registration interface, configured to accept scheduling logic registered at the non-privilege level, and the second thread is determined by using the scheduling logic.

In a further example, the confirming, by the thread management module, that a thread switching context is valid includes: confirming, by the thread management module, that a target register related to the second thread is correctly initialized and is not modified by non-privileged code.

According to a second aspect, a management apparatus for managing a user-mode program in a target operating system is provided. The target operating system is written in a Rust language. The Rust language includes an unsafe keyword. The management apparatus is located at a privilege level and has permission to use the unsafe keyword. The management apparatus includes at least a user-mode interface module and a basic code module.

The user-mode interface module is configured to: in response to a kernel processing program requesting, by calling a preset interface function, to enter a user mode to execute a target program, confirm security of a register access related to the request, where the kernel processing program is located at a non-privilege level and has no permission to use the unsafe keyword, and the user-mode interface module does not include the unsafe keyword.

The basic code module is configured to: activate a target page table corresponding to the target program through the register access by using first code that includes the unsafe keyword, and set a mode of the operating system to the user mode.

According to a third aspect, a computer-readable storage medium is provided. The computer-readable storage medium stores a computer program, and when the computer program is executed in a computer, the computer is enabled to perform the method according to the first aspect.

According to a fourth aspect, a computing device is provided, and includes a storage and a processor. The storage stores executable code, and when the processor executes the executable code, the method according to the first aspect is implemented.

In the user-mode program management architecture provided in the embodiments of this specification, there is a clear boundary between privileged code and non-privileged code. Both the user-mode program and the kernel processing program that directly interacts with the user-mode program are located at the non-privilege level and have no permission to use unsafe code. The management module is located at the privilege level, and includes the basic code module that directly uses the unsafe code and auxiliary modules that do not include the unsafe code but provide a security protection mechanism to the management module. These auxiliary modules include the user-mode interface module and the intermediate module and the thread management module that are optional. In addition, these auxiliary modules function as interfaces, and interact with a program at the non-privilege level. In this way, in code related to the user-mode program, the privilege level includes only the unsafe code and necessary related security protection code, and needs to be reviewed before being put into use. This restricts a programmer from arbitrarily using the unsafe keyword, and minimizes a trusted base of the operating system, thereby improving system stability and security.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram of a management architecture according to an embodiment;

FIG. 2 is a flowchart of a management process for entering a user mode;

FIG. 3 is a schematic diagram of a management process for entering a user mode;

FIG. 4 is a schematic diagram of management of a thread management module according to an embodiment; and

FIG. 5 is a schematic structural diagram of a management apparatus according to an embodiment.

### DESCRIPTION OF EMBODIMENTS

The following describes, with reference to the accompanying drawings, the solutions provided in this specification.

In the following, an operating system written in a Rust language is briefly referred to as a Rust operating system. As described above, Rust provides an unsafe keyword, and some mandatory checks by a Rust compiler can be avoided for a code segment identified by the keyword. Therefore, a trusted base of the Rust operating system closely depends on use of the unsafe keyword.

A trusted base is a set of all security protection mechanisms for implementing security protection of a computer system. The trusted base of the Rust operating system includes all modules using the unsafe keyword, including unsafe-used code and unsafe-marked code. For a module that includes the unsafe-used code, a security condition required by the unsafe-marked code needs to be met, so that no security problem occurs in the system. This is a protection mechanism made for protecting system security, and therefore is incorporated into the trusted base. A module that includes the unsafe-marked code causes the system to generate more unsafe-used code modules. If the unsafe-used code module is incorporated into the trusted base, the unsafe-marked code needs to be synchronously incorporated. As the Rust operating system becomes increasingly large, if the unsafe-used code is not reduced and managed, the trusted base of the Rust operating system becomes increasingly large, which adversely affects security, stability, and maintainability of the operating system.

In some existing Rust operating systems such as Thesus, RedLeaf, and Tock, some efforts are made in managing the unsafe keyword. However, permission of a programmer to use the unsafe still cannot be effectively restricted, arbitrary writing of the unsafe keyword is not fundamentally prevented, and a code amount of the unsafe keyword and a security protection mechanism thereof cannot be effectively reduced. Consequently, the system still has a relatively great security and stability risk.

It is known to a person skilled in the art that an operating system needs to provide running environment support to a user-mode program at an upper layer. Running and management of the user-mode program involve switching of the operating system between a kernel mode and a user mode, and may further involve thread scheduling and switching. All of these are implemented by using lower-level code in a kernel. For these management functions, if the programmer is allowed to use the unsafe code without restriction, a trust problem and a security problem are caused. Therefore, in terms of user-mode program management, how to more effectively manage and restrict use of the unsafe keyword and reduce the system trusted base is of great significance for improving system security and stability.

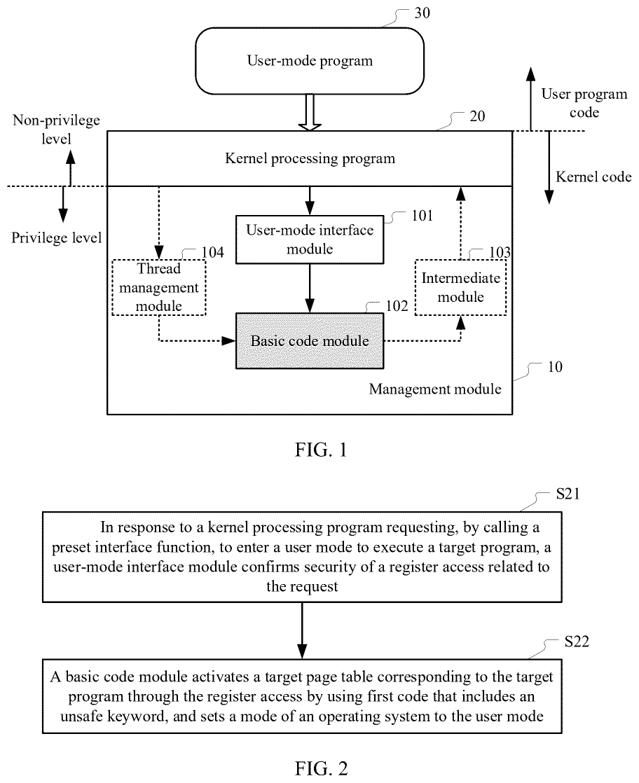

Therefore, in the embodiments of this specification, a method and an architecture for managing a user-mode program are provided. FIG. 1 is a schematic diagram of a management architecture according to an embodiment. Based on this architecture, code related to running and management of a user-mode program is classified into a privilege level and a non-privilege level. The non-privilege level has no permission to use an unsafe keyword, and the privilege level has permission to use unsafe code. To restrict, from the source, a programmer from arbitrarily writing code that includes unsafe and minimize a trusted base as much as possible, as shown in the figure, all of user-mode program code 30 is located at the non-privilege level, a kernel processing program 20 that is in system kernel code and that is directly connected to the user-mode program is also located at the non-privilege level, and only some of the system kernel code is classified into the privilege level. In the management architecture of this solution, the privilege level includes only the unsafe code and additional security protection mechanism code generated to achieve system security. Code logic at the privilege level needs to be strictly reviewed before being put into use.

Specifically, in the management architecture in FIG. 1, a management module 10 is disposed at the privilege level, and is configured to manage a running status and task scheduling of program code. The management module 10 further includes a user-mode interface module 101 and a basic code module 102. The user-mode interface module 101 is configured to be connected to a processing program at the non-privilege level to process a requirement for entering a user mode. The basic code module 102 is shown in a gray background, indicating that the basic code module 102 includes code identified by an unsafe keyword. Specifically, the basic code module 102 performs the most underlying and basic operations such as a register operation and an assembly language instruction by using code that includes the unsafe keyword, so that a system enters the user mode. The user-mode interface module 101 does not include the unsafe code, but provides assurance for correct and secure execution of the basic code module 102 that includes the unsafe code, and is protection mechanism code made to protect system security, and therefore also belongs to the privilege level.

Optionally, the management module 10 further includes an intermediate module 103, configured to: when the operating system is enabled to enter a kernel mode when a specific trigger event occurs, perform target processing corresponding to the trigger event. The trigger event is one of a system call, an external interrupt, or a CPU exception. In this way, the intermediate module 103 provides an intermediary service between the executed user-mode program and the kernel processing program, and performs data forwarding between the user-mode program and the kernel processing program.

Optionally, the management module 10 further includes a thread management module 104, configured to perform thread management. Specifically, the thread management module 104 can perform a security check and assurance when the system needs to perform thread switching. In a scenario in which the user-mode program is executed, when switching from a currently executed user-mode thread to another thread needs to be performed, the thread management module 104 can first confirm that a thread switching context is valid, and then perform thread switching by executing the unsafe code of the code module. The thread management module 104 can further provide a registration interface, configured to accept registration of thread scheduling logic at the non-privilege level.

Both the intermediate module 103 and the thread management module 104 do not include the unsafe code, but serve as auxiliaries and assurance for execution security of the basic code module 102.

The following describes in detail a management process based on the above-mentioned management architecture in various scenarios in which a user-mode program runs.

For management of the user-mode program, entering a user mode is the most basic and typical requirement. Entering the user mode is usually initiated by a kernel processing program in the following several cases. In a case, a system needs to start a user-mode program. For example, in response to a system requirement or a user requirement, some user-mode programs need to be started and executed. In another case, after completing some operations in a kernel mode, the system needs to return to a previously executed user-mode program. For example, when the user-mode program requests, by using a system call, the operating system to complete some operations (for example, file reading and memory allocation), after completing the request in the kernel mode, the operating system needs to return to the user mode from the kernel mode, and continues to execute the user-mode program. Alternatively, when a hardware device requests a service from the operating system through an interrupt, the operating system switches from the user mode to the kernel mode to respond to and process the interrupt. Once interrupt processing is completed and no other kernel-level tasks currently need to be processed, the operating system needs to switch back to the user mode. Alternatively, when an exception occurs when the user-mode program runs, the operating system processes the exception, and switches back to the user mode after completion of the processing. There are further other cases such as reselecting a process by a scheduler.

With reference to FIG. 2 and FIG. 3, the following describes a management process for entering a user mode in the plurality of above-mentioned cases. As shown in FIG. 2, the method includes the following steps. In step S21, in response to a kernel processing program requesting, by calling a preset interface function, to enter a user mode to execute a target program, a user-mode interface module determines a to-be-executed register access based on the request, and confirms security of the register access. In step S22, a basic code module activates a target page table corresponding to the target program through the register access by using first code that includes an unsafe keyword, and sets a mode of an operating system to a user mode.

Specifically, as shown in FIG. 3, a management module can provide an interface function, for example, an execute function, to the outside. When the operating system needs to enter the user mode, the kernel processing program executes or calls the execute function to request to enter the user mode. More specifically, when the kernel processing program calls the execute function, a structure instance specified by a privilege level needs to be imported, and the structure instance includes information about the to-be-executed target user-mode program A. The information can include identification information of the target program A, register information, etc. In other words, the kernel processing program can send a request by calling the interface function, and request the system to enter the user mode to execute the target program A.

When the execute interface function is called, the user-mode interface module determines, based on function information of the interface function and information imported during the call, the register access related to the request. The register access is a register access that needs to be executed and that is related to entering the target user-mode program. The user-mode interface module then confirms the security of the register access.

Because entering the user mode requires activation of a user-mode page table by performing writing into a page table base address register, in an embodiment, the user-mode interface module first confirms that the target page table PT-A corresponding to the target program A is valid. Because a page table of each program is stored in a memory, maintenance and management of the page table involve memory management. In an embodiment, a memory management module configured to manage the memory is disposed at the privilege level, and includes a page table management submodule. The page table management submodule can perform some security checks to ensure that a base address of the target page table is not modified after an instance of the page table is created. Correspondingly, the user-mode interface module can call the memory management module to confirm that the base address of the target page table PT-A is not modified, and confirm that an instance of the target page table PT-A can be obtained. If it cannot be confirmed that the target page table PT-A is valid, the user-mode interface module cannot confirm that a subsequent register access can be normally and securely executed, and can stop subsequent execution, and return error information to the kernel processing program.

On the basis of confirming that the target page table PT-A is valid, the user-mode interface module further confirms that the register access that needs to be executed includes only one register write operation of performing writing into a base address register based on the base address of the target page table PT-A, and all other accesses are register read operations performed to implement data extraction. This is because writing the base address of the target page table PT-A into the base address register is a necessary operation for activating the target page table, and a register access other than this should involve only register reading performed for data extraction, for example, reading a register CR2 for extracting a page error address. If the to-be-executed register access determined based on the call information includes another register write operation, the user-mode interface module can stop subsequent execution, and return error information to the kernel processing program.

After the user-mode interface module confirms the security of the related register access, the basic code module activates the target page table PT-A corresponding to the target program A through the register access by using the first code that includes the unsafe keyword, and sets the mode of the operating system to the user mode.

Specifically, the first code usually can be assembly instruction code, and is used to perform a register access operation and some setting operations. The register access operation can include: writing the base address of the target page table PT-A into the page table base address register, to activate the target page table PT-A; and reading and restoring values of several general-purpose registers corresponding to the target program A. The general-purpose registers can include a register that stores a program calculator PC, a register that stores a stack pointer, and another possible register that stores an execution status of the target program A. The setting operation can include: setting a running permission level of a CPU to the user mode, and setting a register (for example, a general-purpose register rcx in x86-64) that stores a current execution location to an address Add-A stored in a specific register (for example, a register that stores a program counter) of the target program A. In this way, the mode of the operating system is switched to the user mode, so that the operating system jumps to the address Add-A, and starts to execute an instruction in the target program A based on the target page table PT-A.

Through the above-mentioned management process of the management module, the operating system enters the user mode and executes the target program A. In an execution process of the target program A, if some trigger events occur, the operating system needs to switch back to a kernel mode. Therefore, as shown in FIG. 1, an intermediate module is further disposed in the management module, and the intermediate module is configured to: perform processing corresponding to the trigger event, and forward and transmit necessary data between the kernel processing program and the target program A.

Specifically, the trigger event can include a system call, an external interrupt, or a CPU exception. The system call refers to a call request sent by the target program A to a system function in an execution process when some functions need to use a system kernel service (for example, file reading and memory allocation). The external interrupt is triggered by a peripheral hardware device (for example, a keyboard, a mouse, or a network interface card), and is used to report some events that need to be processed by a system kernel to the CPU. The CPU exception is a case in which an error occurs during execution of the target program A. For example, when there is division by zero or an invalid memory address is accessed, the CPU exception is triggered.

When the system call, the CPU exception, or the external interrupt occurs, the operating system kernel needs to provide a service or processing. Therefore, the system needs to switch from the user mode to the kernel mode. Therefore, when the above-mentioned several types of trigger events occur, the operating system enters the kernel mode. In addition, the intermediate module determines a type of the trigger event, and performs target processing corresponding to the trigger event.

Specifically, when the trigger event is a system call, the intermediate module returns the kernel processing program at a non-privilege level based on running data of the target program A. For example, after the operating system is switched to the user mode by using the first code, the target program A is executed. After switching to the kernel mode is performed, the first code can return and provide some running data of the target program A. The running data can include a value of each register, related data in a stack or a heap, call data for making a system call, etc. The intermediate module can return the running data to the kernel processing program, and the kernel processing program performs subsequent processing. In this case, the intermediate module functions as a forwarding intermediary for interaction between the kernel processing program at the non-privilege level and the target program A.

A second trigger case is the external interrupt. To process the external interrupt, an interrupt management module can be disposed at the privilege level to allocate an interrupt vector number, accept registration of an interrupt function, and securely process the external interrupt. Therefore, when the trigger event is an external interrupt, the intermediate module jumps to the interrupt management module and imports the interrupt vector number, to enable an interrupt processing function corresponding to the external interrupt to be executed. It can be understood that the external interrupt is sent by a peripheral device. During starting or initialization, each peripheral device registers an interrupt processing function corresponding to each peripheral device through the interrupt management module. When a peripheral device sends an external interrupt, the intermediate module enables an interrupt processing function registered by the peripheral device in advance to be executed at the privilege level.

When the trigger event is a CPU exception, the intermediate module further performs different processing based on an exception type. If a first-type exception occurs, the intermediate module jumps back to the kernel processing program. The first-type exception includes various types of memory page errors, for example, an invalid memory address and a mapping error. If a second-type exception occurs, the intermediate model performs related exception processing at the privilege level. The second-type exception includes an exception case such as a virtual exception.

In this way, when switching from the target user-mode program A to the kernel mode is performed, processing and forwarding are performed through the intermediate module, to avoid direct interaction between a program running at the privilege level and the kernel processing program at the non-privilege level.

In a running process of the target user-mode program A, thread switching is usually further involved. Therefore, a thread management module is further provided in the management module at the privilege level, to manage and schedule a thread and provide corresponding security assurance.

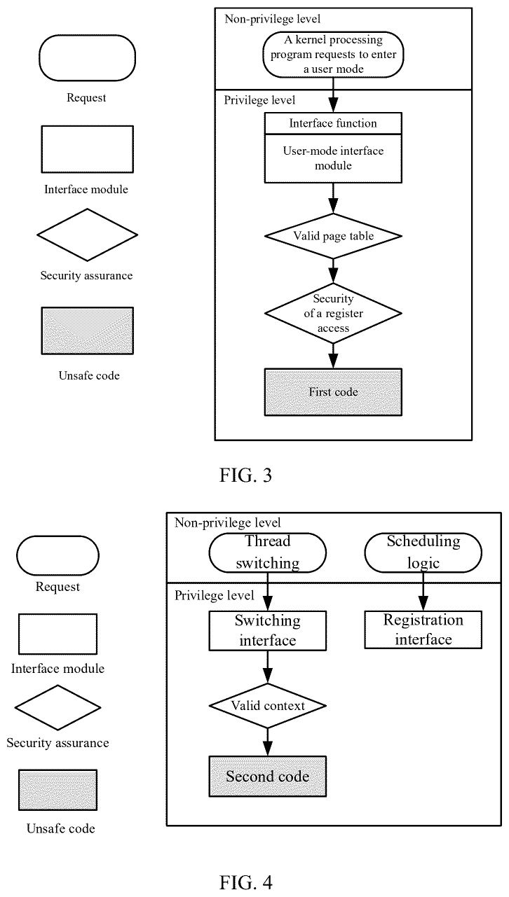

FIG. 4 is a schematic diagram of management of a thread management module according to an embodiment. It can be understood that thread-related management mainly includes thread scheduling and thread switching. For thread scheduling, as shown in FIG. 4, the thread management module provides a registration interface to accept scheduling logic registered at the non-privilege level. That is, after the scheduling logic is implemented at the non-privilege level, registration with the thread management module at the privilege level can be performed through the registration interface. In practice, the scheduling logic and a process of using the scheduling logic usually do not involve unsafe code. Therefore, the scheduling logic and a corresponding scheduler can be placed at the non-privilege level through registration, and the privilege level provides only the registration interface and calls the scheduling logic when needed. In this way, a code amount at the privilege level can be minimized, thereby reducing a trusted base.

For thread switching, the thread management module provides security assurance for thread switching through a switching interface. When the system sends a requirement for switching from a current thread 1 to a target thread 2 (for example, after the scheduler performs thread scheduling by using the scheduling logic), the switching interface obtains at least a thread instance of the target thread, and confirms, based on this, that a thread switching context is valid. Specifically, the thread instance is a structure instance obtained by encapsulating a thread-related register, a kernel stack, and a thread status in a structure. The thread-related register can include a register that stores an instruction pointer, a stack pointer SP register, and a register configured to temporarily store intermediate data in a code running process, for example, a rax register or an rbx register. All of these registers are encapsulated in structures to form thread instances.

Based on the thread instance, the switching interface determines whether the thread switching context is valid. Specifically, the thread management module confirms that a register related to the target thread is correctly initialized and is not modified by non-privileged code. After it is confirmed that the context is valid, a context switching operation is performed by using kernel code that includes the unsafe keyword.

In a user-mode program management scenario, during running of the target user-mode program A, a case of switching from a currently running first thread in the target program A to a second thread may occur. The second thread can be another thread in the target program A, can be a user-mode thread in another user-mode program, or can be a kernel-mode thread. In this case, the thread management module confirms, based on the second thread, that a thread switching context is valid, and then second code that is in the basic code module and that includes the unsafe keyword performs thread switching, and switches an execution thread to the second thread. This process usually includes storing thread instance information of the first thread, loading data in the thread instance of the second thread, and setting the current execution thread to the second thread. The above-mentioned process involves a register access operation and some assembly setting operations in the thread instance, all of which need to be implemented by using the unsafe code.

In a scenario in which running of a user-mode program is involved, another thread switching requirement can be a requirement for switching from another thread (for example, a kernel-mode thread) to a thread in the target program A. Similar to the above-mentioned process, the thread management module verifies a thread switching context, and then thread switching is performed by using the unsafe code.

The above-mentioned various types of thread switching requirements can be results of thread scheduling arrangements made by the scheduler based on the scheduling logic. As described above, the scheduling logic can be implemented by using the non-privileged code, and registered with the thread management module through the registration interface. In this way, the thread management module provides security assurance for thread switching during program running.

With reference to the above-mentioned management aspects of the management module, it can be seen that in the management architecture of this solution, there is a clear boundary between privileged code and non-privileged code. Both the user-mode program and the kernel processing program that directly interacts with the user-mode program are located at the non-privilege level and have no permission to use unsafe code. The management module is located at the privilege level, and includes the basic code module that directly uses the unsafe code and auxiliary modules that do not include the unsafe code but provide a security protection mechanism to the management module. These auxiliary modules include the user-mode interface module and the intermediate module and the thread management module that are optional. In addition, these auxiliary modules function as interfaces, and interact with a program at the non-privilege level. In this way, in code related to the user-mode program, the privilege level includes only the unsafe code and necessary related security protection code, and needs to be reviewed before being put into use. This restricts a programmer from arbitrarily using the unsafe keyword, and minimizes a trusted base of the operating system, thereby improving system stability and security.

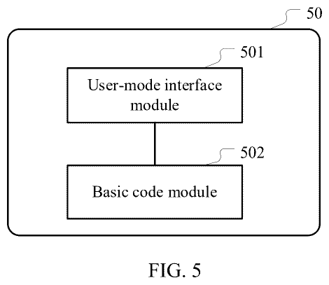

In addition, corresponding to the above-mentioned method process, an embodiment of this specification further provides a management apparatus for managing a user-mode program in a target operating system. The target operating system is written in a Rust language. The Rust language includes an unsafe keyword. FIG. 5 is a schematic structural diagram of a management apparatus according to an embodiment. As shown in the figure, the management apparatus 50 includes at least a user-mode interface module 501 and a basic code module 502.

The user-mode interface module 501 is configured to: in response to a kernel processing program requesting, by calling a preset interface function, to enter a user mode to execute a target program, determine security of a register access related to the request, where the kernel processing program is located at a non-privilege level and has no permission to use the unsafe keyword, and the user-mode interface module does not include the unsafe keyword.

The basic code module 502 is configured to: activate a target page table corresponding to the target program through the register access by using first code that includes the unsafe keyword, and set a mode of the operating system to the user mode.

For a specific execution process example of the device management process, refer to the above-mentioned descriptions provided with reference to FIG. 2 to FIG. 4. Details are not described again.

According to an embodiment in still another aspect, a computing device is further provided, including a storage and a processor. The storage stores executable code, and when the processor executes the executable code, the method described with reference to FIG. 2 to FIG. 4 is implemented.

A person skilled in the art should be aware that in the above-mentioned one or more examples, functions described in this specification can be implemented by hardware, software, firmware, or any combination thereof. When being implemented by software, these functions can be stored in a computer-readable medium or transmitted as one or more instructions or code on a computer-readable medium.

In the above-mentioned specific implementations, the objectives, technical solutions, and beneficial effects of this specification are further described in detail. It should be understood that the above-mentioned descriptions are merely specific implementations of this specification, but are not intended to limit the protection scope of this specification. Any modification, equivalent replacement, improvement, etc. made based on the technical solutions of this specification shall fall within the protection scope of this specification.

1. A method for managing a user-mode program in a target operating system, wherein the target operating system is written in a Rust language, the Rust language comprises an unsafe keyword, the method is performed by a management module at a privilege level, the privilege level has permission to use the unsafe keyword, the management module comprises at least a user-mode interface module and a basic code module, and the method comprises:
in response to a kernel processing program requesting, by calling a preset interface function, to enter a user mode to execute a target program, determining, by the user-mode interface module, a to-be-executed register access based on the request, and confirming security of the register access, wherein the kernel processing program is located at a non-privilege level and has no permission to use the unsafe keyword, and the user-mode interface module does not comprise the unsafe keyword; and
activating, by the basic code module, a target page table corresponding to the target program through the register access by using first code that comprises the unsafe keyword, and setting a mode of the operating system to the user mode.

2. The method according to claim 1, wherein confirming security of the register access comprises:
confirming, by the user-mode interface module, that the target page table is valid; and
confirming, by the user-mode interface module, that the register access comprises only one register write operation of performing writing into a base address register based on the target page table, and all other accesses are register read operations performed to implement data extraction.

3. The method according to claim 2, wherein a memory management module is further disposed at the privilege level, and confirming, by the user-mode interface module, that the target page table is valid comprises:
calling, by the user-mode interface module, the memory management module to confirm that a base address of the target page table is not modified.

4. The method according to claim 2, wherein activating the target page table corresponding to the target program through the register access comprises:
writing a base address of the target page table into the base address register; and
restoring values of several general-purpose registers, wherein the several general-purpose registers are configured to store a program counter, an instruction pointer, and a stack pointer.

5. The method according to claim 1, wherein the management module further comprises an intermediate module, the intermediate module does not comprise the unsafe keyword, and the method further comprises:
in response to a target trigger event that enables the operating system to enter a kernel mode, performing, by the intermediate module, target processing corresponding to the target trigger event, wherein the target trigger event is one of a system call, an external interrupt, or a CPU exception.

6. The method according to claim 5, wherein performing, by the intermediate module, target processing corresponding to the target trigger event comprises:
when the target trigger event is a system call, returning, by the intermediate module, the kernel processing program based on running data of the target program.

7. The method according to claim 1, wherein the management module further comprises a thread management module, the thread management module does not comprise the unsafe keyword, and the method further comprises:
in response to a request for switching from a currently executed first thread in the target program to a second thread, confirming, by the thread management module, that a thread switching context is valid; and
switching, by the basic code module, an execution thread to the second thread by using second code that comprises the unsafe keyword.

8. The method according to claim 7, wherein the second thread is one of the following: another thread in the target program, a user-mode thread in another user-mode program, and a kernel thread.

9. The method according to claim 7, wherein the thread management module has a registration interface, configured to accept scheduling logic registered at the non-privilege level, and the second thread is determined by using the scheduling logic.

10. The method according to claim 7, wherein confirming, by the thread management module, that the thread switching context is valid comprises:
confirming, by the thread management module, that a target register related to the second thread is correctly initialized and is not modified by non-privileged code.

11. (canceled)

12. A computing device, comprising a storage and a processor, wherein the storage stores executable code, and when executing the executable code, the processor is caused to implement a method for managing a user-mode program in a target operating system, wherein the target operating system is written in a Rust language, the Rust language comprises an unsafe keyword, the method is performed by a management module at a privilege level, the privilege level has permission to use the unsafe keyword, the management module comprises at least a user-mode interface module and a basic code module, and the method comprises:
in response to a kernel processing program requesting, by calling a preset interface function, to enter a user mode to execute a target program, determining, by the user-mode interface module, a to-be-executed register access based on the request, and confirming security of the register access, wherein the kernel processing program is located at a non-privilege level and has no permission to use the unsafe keyword, and the user-mode interface module does not comprise the unsafe keyword; and
activating, by the basic code module, a target page table corresponding to the target program through the register access by using first code that comprises the unsafe keyword, and setting a mode of the operating system to the user mode.

13. The computing device according to claim 11, wherein confirming security of the register access comprises:
confirming, by the user-mode interface module, that the target page table is valid; and
confirming, by the user-mode interface module, that the register access comprises only one register write operation of performing writing into a base address register based on the target page table, and all other accesses are register read operations performed to implement data extraction.

14. The computing device according to claim 12, wherein a memory management module is further disposed at the privilege level, and confirming, by the user-mode interface module, that the target page table is valid comprises:
calling, by the user-mode interface module, the memory management module to confirm that a base address of the target page table is not modified.

15. The computing device according to claim 12, wherein activating the target page table corresponding to the target program through the register access comprises:
writing a base address of the target page table into the base address register; and
restoring values of several general-purpose registers, wherein the several general-purpose registers are configured to store a program counter, an instruction pointer, and a stack pointer.

16. The computing device according to claim 11, wherein the management module further comprises an intermediate module, the intermediate module does not comprise the unsafe keyword, and the method further comprises:
in response to a target trigger event that enables the operating system to enter a kernel mode, performing, by the intermediate module, target processing corresponding to the target trigger event, wherein the target trigger event is one of a system call, an external interrupt, or a CPU exception.

17. The computing device according to claim 15, wherein performing, by the intermediate module, target processing corresponding to the target trigger event comprises:
when the target trigger event is a system call, returning, by the intermediate module, the kernel processing program based on running data of the target program.

18. The computing device according to claim 11, wherein the management module further comprises a thread management module, the thread management module does not comprise the unsafe keyword, and the method further comprises:
in response to a request for switching from a currently executed first thread in the target program to a second thread, confirming, by the thread management module, that a thread switching context is valid; and
switching, by the basic code module, an execution thread to the second thread by using second code that comprises the unsafe keyword.

19. The computing device according to claim 17, wherein the second thread is one of the following: another thread in the target program, a user-mode thread in another user-mode program, and a kernel thread.

20. The computing device according to claim 17, wherein the thread management module has a registration interface, configured to accept scheduling logic registered at the non-privilege level, and the second thread is determined by using the scheduling logic.

21. A non-transitory computer-readable storage medium, wherein the storage medium stores a computer program, and when the computer program is executed by a processor, the processor is caused to implement a method for managing a user-mode program in a target operating system, wherein the target operating system is written in a Rust language, the Rust language comprises an unsafe keyword, the method is performed by a management module at a privilege level, the privilege level has permission to use the unsafe keyword, the management module comprises at least a user-mode interface module and a basic code module, and the method comprises:
in response to a kernel processing program requesting, by calling a preset interface function, to enter a user mode to execute a target program, determining, by the user-mode interface module, a to-be-executed register access based on the request, and confirming security of the register access, wherein the kernel processing program is located at a non-privilege level and has no permission to use the unsafe keyword, and the user-mode interface module does not comprise the unsafe keyword; and
activating, by the basic code module, a target page table corresponding to the target program through the register access by using first code that comprises the unsafe keyword, and setting a mode of the operating system to the user mode.
